(19) United States
(12) Patent Application Publication
(10) Pub. No.: US 2026/0103380 A1
(43) Pub. Date: Apr. 16, 2026

(54) Method For Synthesising A Material For A Lithium-Ion Battery Consisting Of Nanoporous Lithium Iron Phosphate Particles

(71) Applicants: OCP SA, Casablanca (MA); Universite Mohammed VI Polytechnique, Benguerir (MA)

(72) Inventors: Mouad Dahbi, Ben Guerir (MA); Nawal Semlal, El Jadida (MA); Mohamed Aqil, Oujda (MA); Jones Alami, Fes (MA); Abdelhay Aboulaich, Marrakech (MA)

(73) Assignees: OCP SA, Casablanca (MA); Universite Mohammed VI Polytechnique, Benguerir (MA)

(21) Appl. No.: 19/116,788

(22) PCT Filed: Oct. 2, 2023
(86) PCT No.: PCT/MA2023/050014

§ 371 Date: Mar. 28, 2025

(30) Foreign Application Priority Data
Sep. 29, 2022 (FR) FR2209938

(51) Int. Cl. C01B 25/45; H01M 10/0525

(52) U.S. Cl. CPC C01B 25/45; H01M 10/0525; C01P 2002/72; C01P 2004/03; C01P 2004/84; C01P 2006/16; C01P 2006/40

(57) ABSTRACT

The invention concerns a method for synthesizing a lithium-ion battery material consisting of nanoporous lithium iron phosphate particles (1), the method comprising the following steps:
(E1) forming a precipitation solution by mixing a lithium source (4), an iron(II) source (5), a phosphorus source (6), a reducing agent (8) and carbon nano-objects (7) in a solvent so as to coprecipitate lithium, iron and phosphorus around the carbon nano-objects in the form of particles, referred to as LFP/C (9), lithium iron phosphate particles incorporating the carbon nano-objects;
(E2) separating the LFP/C (9) particles from the precipitation solution;
(E3) drying the LFP/C particles (9);
(E4) calcining the LFP/C particles (9) so as to decompose the carbon nano-objects (7) incorporated in the particles, the decomposition of the nano-objects (7) generating nanopores (3) within the lithium iron phosphate particles.

### TECHNICAL FIELD

The invention concerns a method for synthesizing a lithium-ion battery material composed of nanoporous lithium iron phosphate particles.

### STATE OF THE ART

Rechargeable lithium-ion (Li-ion) batteries are currently one of the leading energy storage solutions. Due to their high energy density and long service life, they are widely used in mobile phones, computers, household appliances, electric and hybrid vehicles as well as in renewable energy storage stations. The areas of application and the performance of these batteries have been constantly evolving for several years.

### An Li-Ion Battery has Three Main Components:

a cathode comprising a lithium-containing material, a binder such as polyvinylidene fluoride, and an electrically conductive material such as carbon black, the lithium-containing material, the binder and the electrically conductive material being randomly mixed so as to form an organic-inorganic composite material, the composite material comprising, by mass, around 85% lithium-containing material, 10% electrically conductive material and 5% binder;
a liquid electrolyte containing a lithium salt that wets a thin plastic or polymeric sheet, called a separator;
an anode made of a carbon-based material, for example graphite.

The battery charging/discharging cycles operate via oxidation-reduction reactions which are accompanied by a reversible phenomenon of lithium insertion/deinsertion at both electrodes. The electrical conductivity of the two electrodes as well as their structural stability during charge/discharge cycles are therefore essential conditions for the proper functioning of the battery.

Transition metal oxides, such as LiCoO₂ (LCO), LiNiO₂ (LNO) and LiMn₂O₄ (LMO) are widely used cathode materials, but they have a number of disadvantages. For example, the cobalt in LCO is a toxic and expensive metal. In addition, the main cobalt resources (nearly 70%) are concentrated in the Democratic Republic of the Congo (DRC) and Zambia, both politically unstable countries. Using a pure LNO cathode poses a major safety problem related to the instability of the nickel oxide structure after deinsertion of Li and the risk of exothermic reaction of this nickel oxide with the electrolyte. LMO is also thermally and electrochemically unstable during charge/discharge cycles.

Metallic lithium phosphate materials are cathode materials alternative to transition metal oxides. For example, lithium iron phosphate LiFePO₄ (LFP), in the form of particles with an olivine-type crystal structure, has a high operating voltage of approximately 3.4V (vs. Li⁺/Li) and a high theoretical capacity, of around 170 mAh/g. In addition, LFP has excellent chemical and thermal stability and does not use toxic and/or expensive metals. Such characteristics make this material particularly advantageous for applications in which safety issues are decisive, for example in electric vehicles.

However, this material suffers from weak Lit ion diffusion kinetics within it and has poor electronic conductivity, which results in a significant loss of capacitance, especially at high charge/discharge rates. Several strategies have been developed to improve these properties, such as, for example, reducing the size of the LFP particles, surface coating the particles with a carbon layer or manufacturing LFP/C composites and doping with transition metals. Surface coating LFP particles with a carbon layer or manufacturing LFP and carbon composites, denoted LFP/C, increases the electronic conductivity of LFP particles.

The size and morphology of the LFP particles play a crucial role in the electrochemical performance of the cathode. Nano-sized LFP particles make it possible to obtain a very good power density. Indeed, the diffusion paths for the lithium ions are short and the exchange surface area between the electrolyte and the cathode is large, which facilitates the lithium ion insertion/deinsertion processes during charge/discharge cycles. In return, nanosized LFP particles lead to a low volumetric energy density due to a large specific surface area and a high quantity of binders that tend to adsorb on the surface of the particles, thus giving rise to undesirable reactions and poor electrochemical stability during cycling.

One solution to the particle size problem is to prepare micro-nanostructured LFP which comprises micrometric particles having nanometric pores. The preparation of micro-nanostructured LFP significantly improves the electrochemical performance of the LFP/C cathode. During cycling, the micro-nanostructured LFP combines a high charge/discharge rate offered by the nanometric structure with a high volumetric energy density and good electrochemical stability provided by the micrometric dimension. In addition, the larger the nanopores, the more they increase the surface area for exchange with the electrolyte, and therefore the more they improve the transport properties of Lit ions between the two electrodes. A battery comprising such a material has high charging and discharging rates, especially at a high current flow.

Controlling particle size and morphology to improve material properties requires precise control of synthesis parameters during the various manufacturing steps. Synthesis methods based on solid state reactions, which are widely used on an industrial scale, have major disadvantages. It is difficult to obtain a homogeneous mixture of precursors in the solid state and to control the morphology and particle size of the final material. To overcome these difficulties, solid state synthesis methods involve several steps of mixing, mechanical grinding and high temperature heat treatment, making the manufacturing method time and energy consuming.

Wet synthesis methods make it possible to overcome homogeneity problems since lithium, iron and phosphorus precursors are mixed in the atomic or molecular state in an organic solvent or water, making it possible to obtain a high chemical purity/crystal quality LFP cathode at lower temperatures compared to solid state synthesis methods. These methods, called “soft”, also make it easier to control the morphology and size of LFP particles. However, they have disadvantages that make their transfer to industrial scale complex or economically unprofitable.

Sol-gel synthesis, for example, uses expensive and flammable organic solvents and organic precursors, such as acetates, which are relatively expensive. Steps of drying, grinding and heat treating the intermediate product (xerogel) are also indispensable. The sol-gel method is therefore long, expensive and restrictive from the industrial and environmental viewpoints.

The document US2014/0342231 A1 discloses a method for hydrothermally synthesizing LFP/C particles from a lithium ion source, an iron source, a phosphorus source and a first carbon source. These precursors are dissolved in water and mixed with a second carbon source based on carbon nanofibers before being transferred to the autoclave. The precipitate is then calcined to form LFP/C composite particles coated with a carbon coating incorporating the second carbon source. The carbon coating aims to improve the electronic conductivity of the LFP particles.

The hydrothermal synthesis method uses pressurized reactors that pose safety problems and require a relatively high investment cost. Other variants of this method, such as, for example, solvothermal synthesis, allow the pressure in the reactors to be lowered but use high-boiling organic solvents, such as polyethylene glycol (PEG), which are relatively expensive.

The document US2011/0027651 A1 discloses a method of synthesis by coprecipitation of micro-nanostructured LFP/C particles (microparticles having nanopores) in two synthesis steps. The first synthesis step consists of obtaining FePO₄ particles by reaction between an iron (III) ion precursor and a phosphorus source. The particles obtained are then calcined. In a second synthesis step, the calcined FePO₄ particles are mixed with a carbon source in a solvent. After evaporation of the solvent, a lithium precursor is added and all the precursors are calcined. The two-step coprecipitation process produces micrometric particles coated with a carbon coating and exhibiting nanometric porosity.

However, this coprecipitation method still has disadvantages. Thus, the method is based on a synthesis in two steps and on several mechanical mixing and grinding stages. The method is therefore long, complex and energy-intensive. In addition, the method uses toxic and flammable organic solvents, especially to disperse the carbon source. Finally, the method uses an iron (III) source that requires the use of a reducing gas to reduce the iron (III) ions to iron(II) ions necessary to obtain the FePO₄ phase in the first calcination step. However, the handling and storage of a reducing gas such as dihydrogen on an industrial scale is a risk that should be avoided.

### BRIEF DESCRIPTION OF THE INVENTION

The invention aims to design a method for the preparation of micrometric LFP/C particles having nanometric porosity, for use as cathode material for a lithium-ion battery, which makes it possible to control the porosity of the particles while being easy to implement and having a reduced cost.

To this end, the invention proposes a method for synthesizing a lithium-ion battery material composed of nanoporous lithium iron phosphate particles, the method comprising the following steps:
(E1) forming a basic precipitation solution by mixing a lithium source (4), an iron(II) source, a phosphorus source, a reducing agent and carbon nano-objects in a solvent so as to coprecipitate lithium, iron and phosphorus around the carbon nano-objects in the form of particles, referred to as LFP/C, lithium iron phosphate particles incorporating the carbon nano-objects;
(E2) separating the LFP/C particles from the precipitation solution;
(E3) drying the LFP/C particles;
(E4) calcining the LFP/C particles so as to decompose the carbon nano-objects incorporated in the particles, the decomposition of said nano-objects generating nanopores within the lithium iron phosphate particles.

The method comprises a single coprecipitation synthesis step, which also minimizes the number of mechanical mixing, grinding and heat treatment steps. The cost-effectiveness of the method for preparing micro-nanostructured LFP/C particles by coprecipitation is improved.

In addition, the method advantageously allows controlling the morphology, particle size and porosity of the micro-nanostructured LFP/C particles obtained at the end of this single synthesis step.

Finally, during the single step of synthesizing LFP/C particles by coprecipitation, the method makes it possible to use only water as solvent, avoiding the use of a reducing gas such as dihydrogen, and to operate under temperature and pressure conditions close to ambient. Thus, the method is easily transposable to the industrial scale and less dangerous.

In the present document, the term “micrometric” designates an object at least one dimension of which is less than 1 mm and the term “nanometric” or “nano-” designates an object at least one dimension of which is less than 1 μm.

According to advantageous but optional characteristics of the invention, possibly combined where technically possible:
step (E4) involves the formation of a coating layer around the particles by calcining a carbon source;
the reducing agent is carbon-based and the carbon source comprises said reducing agent;
the carbon source is added to the precipitation solution in step (E1);
the carbon source is added to the LFP/C particles in step (E4);
the carbon nano-objects are chosen so as to obtain, at the end of the calcination step (E4), nanopores of the same size as said carbon nano-objects;
the solvent is an aqueous solution and the carbon nano-objects are water soluble;
the carbon nano-objects comprise carbon quantum dots;
the carbon nano-objects are chosen to decompose at a temperature comprised between 40° and 700° C.;
the carbon nano-objects are carbon nanoparticles obtained from sugars or sugar derivatives dissolved in water, at a concentration comprised between 0.1 M and 2 M, the solution being heated to a temperature greater than 100° C., preferably to a temperature comprised between 150° C. and 200° C. for a duration comprised between 2 h and 4 h;
step (E1) is carried out at atmospheric pressure in an open reactor at a temperature preferably comprised between 50° C. and 90° C.;
the reducing agent used in step (E1) is carbon-based and is preferably chosen from sugars and sugar derivatives, organic acids and glycols;
the mean size of the nanopores within the lithium iron phosphate particles is comprised between 1 nm and 500 nm;
each nanoporous lithium iron phosphate particle is composed of primary particles, the mean diameter of the primary particles preferably being comprised between 50 nm and 500 nm and the mean diameter of the nanoporous lithium iron phosphate particles preferably being between 1 μm and 50 μm;
mixing step (E1) comprises the addition of a base so as to control the pH of the solution during coprecipitation, said base being chosen from the group comprising NH₄OH, NH₄HCO₃, NaOH, KOH, Na₂CO₃, Na₂C₂O₄ or a water soluble organic base;
the formation of the precipitation solution in step (E1) comprises mixing the phosphorus source, the carbon nano-objects, the base and the reducing agent prior to a gradual addition of the lithium source and the iron(II) source, the initial pH of the precipitation solution at the beginning of step (E1) before the introduction of the lithium source being comprised between 1 and 3, preferably between 1.5 and 2.5;
the final pH of the precipitation solution at the end of step (E1) is comprised between 3.5 and 7.5, preferably between 4.5 and 7.

Another object of the invention concerns an Li-ion rechargeable battery containing the material consisting of nanoporous lithium iron phosphate particles obtained by the method as described above.

### BRIEF DESCRIPTION OF THE FIGURES

Other characteristics and advantages of the invention will result from the detailed description which follows, with reference to the attached drawings, in which:

FIG. 1 shows, in the form of a block diagram, the different steps of the LFP/C particle manufacturing method according to the invention;

FIG. 2 shows an embodiment of the step of forming a precipitation solution by mixing a lithium source, an iron(II) source, a phosphorus source and carbon nano-objects in a solvent, so as to coprecipitate LFP/C particles incorporating the carbon nano-objects;

FIG. 3 shows the diagram of an example of an experimental setup for the formation of the precipitation solution according to the embodiment of FIG. 2;

FIG. 4 shows, in the form of a diagram, the process of forming nanoporous LFP/C particles during the precipitation solution formation and calcination steps of the method according to the invention;

FIG. 5 shows the result of X-ray diffraction analysis carried out on the LFP/C particles obtained in Example 3;

FIG. 6 shows an image obtained by scanning electron microscopy of the LFP/C particles obtained in Example 3;

FIG. 7 shows the curve of the first charge/discharge cycle of a battery whose manufacture from the LFP/C particles of Example 3 is described in Example 4;

FIG. 8 shows an image obtained by scanning electron microscopy of the carbon nanoparticles obtained in Example 5;

FIG. 9 shows the result of X-ray diffraction analysis carried out on nanoporous LFP/C particles obtained in Example 7;

FIG. 10 shows an image obtained by scanning electron microscopy performed on the nanoporous LFP/C particles obtained in Example 7;

FIG. 11 shows an image obtained by high magnification scanning electron microscopy of a nanoporous LFP/C particle obtained in Example 7;

FIG. 12 shows an image obtained by scanning electron microscopy of the polished section of a nanoporous LFP/C particle obtained in Example 7;

FIG. 13 shows the curve of the first charge/discharge cycle of a battery whose manufacture from the LFP/C particles of Example 7 is described in Example 8.

For reasons of readability, the drawings are not necessarily made to scale.

Identical references from one figure to another designate the same elements.

### DETAILED DESCRIPTION OF EMBODIMENTS

In the remainder of the description, the expressions “around” or “approximately” mean to within 10%. In addition, the term “mean diameter” is understood to mean, according to the present invention, the diameter of the particles which is greater than the diameter of 50% of the particles and less than the diameter of 50% of the particles. The mean diameter can be measured, for example, from a scanning electron microscopy (SEM) image.

The invention concerns an advantageous and economical method that can be used on an industrial scale to manufacture high-performance metallic lithium phosphates for use as cathode material in lithium-ion rechargeable batteries.

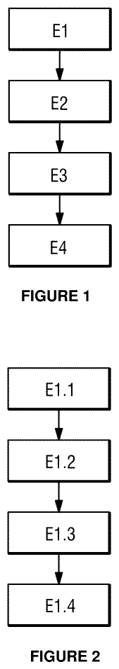

In particular, the invention concerns a method of synthesizing a lithium-ion battery material composed of nanoporous lithium iron phosphate particles comprising the steps shown as a block diagram in FIG. 1. In particular, the method comprises forming a precipitation solution so as to coprecipitate lithium, iron and phosphorus around carbon nano-objects in the form of lithium iron phosphate particles incorporating said carbon nano-objects, and calcining said particles so as to decompose the incorporated nano-objects. The decomposition of the nano-objects generates nanopores within the so-called LFP/C lithium iron phosphate particles so as to generate nanoporous LFP/C particles.

The inventors have observed that the nanopores in the nanoporous lithium iron particles obtained after calcination are approximately of the same size as the carbon nano-objects introduced into the precipitation solution. In the method according to the invention, the carbon nano-objects introduced into the precipitation solution can therefore be chosen so as to obtain, after said calcination step, nanopores of the desired size to obtain the envisaged properties. In fact, the larger the nanopores, the more they increase the surface area for exchange with the electrolyte, and therefore the more they improve the transport properties of Lit ions between the two electrodes. The battery incorporating such a material thus has a high charge and discharge rate, especially at a high current flow rate.

The method according to the invention is concerned with the preparation of nanoporous LFP/C particles whose mean diameter is comprised between 1 μm and 50 μm, preferably between 5 μm and 10 μm. The nanoporous LFP/C particles are themselves composed of primary particles whose mean diameter is preferably comprised between 50 nm and 500 nm.

The size of the nanopores of the LFP/C particles according to the invention may be comprised between 1 nm and 500 nm. Among these particles, microporous particles, with pore sizes below 2 nm, mesoporous particles, with pore sizes comprised between 2 nm and 50 nm, and macroporous particles with pore sizes comprised between 50 nm and 500 nm are conventionally distinguished according to the International Union of Pure and Applied Chemistry (IUPAC). As indicated above, the pore size is advantageously controlled by the size of the carbon nano-objects used in the coprecipitation step. The person skilled in the art can thus choose the type of porosity of the LFP/C particles.

As illustrated in FIG. 1, in a step E1 of the method, a precipitation solution is formed by mixing a lithium source, an iron(II) source, a reducing agent, a phosphorus source and carbon nano-objects in a solvent, so as to cause the lithium, iron(II) and phosphorus to coprecipitate around the carbon nano-objects in the form of lithium iron phosphate particles incorporating the carbon nano-objects, in a single coprecipitation step. These particles are denoted LFP/C.

FIG. 4 schematically represents the mechanism of the coprecipitation reaction implemented during step E1. Firstly, the primary lithium iron phosphate nanoparticles 2 form (\textcircled{1} of FIG. 4). Then, these nanoparticles 2 agglomerate around the carbon nano-objects 7 (\textcircled{2} in FIG. 4). Finally, a maturation and Ostwald ripening phase gives rise to the formation of secondary lithium iron phosphate particles 9 by agglomeration of the primary nanoparticles 2 and incorporation of the carbon nano-objects 7 (\textcircled{3} of FIG. 4).

The coprecipitation reaction is preferably carried out at atmospheric pressure in an open reactor at a temperature comprised between 50° C. and 90° C., even more preferably at a temperature comprised between 60° C. and 80° C. for a period comprised between 1 h and 20 h, preferably between 2 h and 15 h.

Such close to ambient pressure and temperature conditions and the fact that no gas such as dihydrogen is used during the single synthesis step make the method advantageously transposable to the industrial scale and less dangerous. The reaction time is controlled to obtain secondary LFP/C particles of the desired morphology and size. The longer the synthesis time, the larger the size of the secondary particles at the end of the reaction. A person skilled in the art is able to adjust the synthesis time according to the desired particle size.

The iron(II) source (designated by the reference 5 in FIG. 4) is an iron(II) salt, for example FeSO₄·7H₂O or Fe(NO₃)₂.

The lithium source (designated by the reference 4 in FIG. 4) may be chosen from the following precursors: LiOH·1H₂O, Li₂CO₃, LiNO₃, Li₂SO₄·H₂O and LiH₂PO₄. Lithium hydroxide (LiOH·1H₂O) has the advantage of being basic, which contributes favorably to the pH of the coprecipitation medium.

In some embodiments, especially in the case where the lithium source is not LiOH·1H₂O (which is basic), the precipitation solution may also comprise a base. The base is used to control the pH of the precipitation solution and the growth of the LFP particles. The base may be a base of inorganic type such as, for example, ammonium hydroxide (NH₄OH), sodium hydroxide (NaOH), potassium hydroxide (KOH), sodium bicarbonate (Na₂CO₃), ammonium hydrogen carbonate (NH₄HCO₃) and sodium oxalate (Na₂C₂O₄). Alternatively, any type of organic base that is soluble in water can be used.

The phosphorus source (designated by the reference 6 in FIG. 4) may include, for example: H₃PO₄, (NH₄)₃PO₄, (NH₄)₂HPO₄ and/or (NH₄) H₂PO₄.

The carbon nano-objects may comprise, for example, carbon nanospheres, carbon nanorods, carbon nanoparticles, carbon-based quantum dots, and any form of carbon with at least one of its dimensions being sub-micrometric (less than 1 μm). The carbon nano-objects are chosen so as to decompose during the calcination step.

It is obvious to a person skilled in the art that this list of precursors is not exhaustive and can be extended to include several sources of lithium, iron(II), phosphorus and different types of carbon nano-objects soluble in water. Consequently, all possible precursors of lithium, iron(II), phosphorus and carbon nano-objects soluble in water are covered by the scope of this invention.

The precipitation solution according to the invention also comprises a reducing agent (designated by the reference 8 in FIG. 4). Said reducing agent makes it possible to maintain a reducing medium during the precipitation step in order to avoid the oxidation of Fe²⁺ to Fe³⁺ and the formation of unwanted parasitic phases (phases other than the LFP phase).

In a particularly advantageous embodiment, the reducing agent may be carbon based.

When it is carbon based, the reducing agent can have an additional effect to the abovementioned effect of maintaining the reducing medium. Indeed, during the calcination step, the carbon-based reducing agent decomposes to generate a carbon coating layer 24 of the nanoporous LFP/C particles 1, thus improving the electrical conductivity of said particles.

Moreover, the fact that the reducing agent is based on carbon, which is the constituent material of the nano-objects, makes it possible to avoid contaminating the particles with a foreign material.

The carbon-based reducing agent may comprise a sugar and/or a sugar derivative, for example glucose, lactose, fructose and/or dextrose. Alternatively or additionally, the carbon-based reducing agent comprises one or more organic acids chosen from ascorbic acid, citric acid, lauric acid, malonic acid, acrylic acid and/or polyacrylic acid. Alternatively or additionally, the carbon-based reducing agent may comprise one or more glycols such as polyethylene glycol (PEG), tetra-ethylene glycol (TEG) and ethylene glycol (EG).

In other embodiments, the reducing agent may also be chosen from a group comprising inorganic reducing agents, such as: potassium iodide (KI), sodium sulfite (Na₂SO₃), sodium thiosulfate (Na₂S₂O₃), sodium dithionite (Na₂S₂O₄), sodium tetrahydridoborate (NaBH₄).

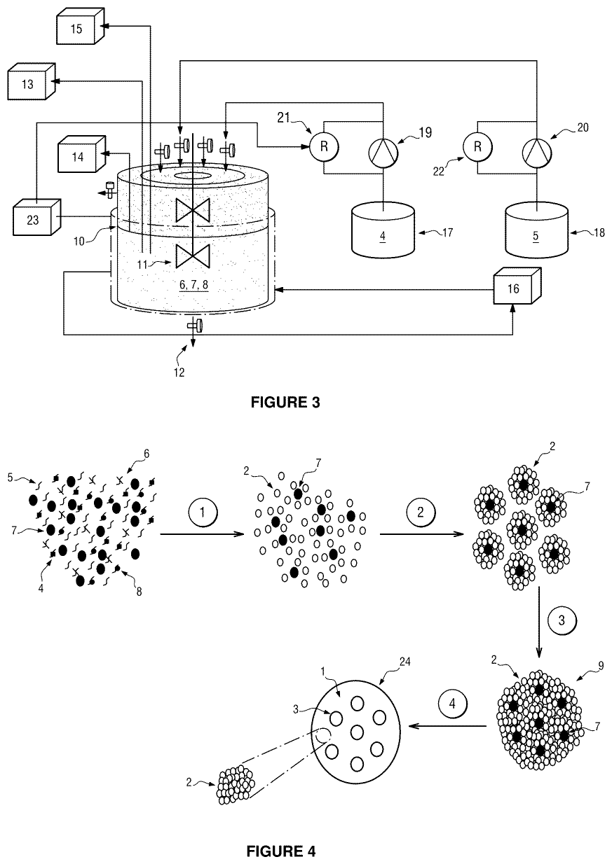

FIGS. 2 and 3 represent a particular embodiment of step E1 of formation of the precipitation solution. In particular, FIG. 2 shows, in the form of a block diagram, the various sub-steps that comprise step E1 according to this embodiment and FIG. 3 shows an example of an experimental device to implement such an embodiment of step E1.

In step E1.1, the phosphorus source and carbon nano-objects are mixed in a double-walled precipitation reactor 10, in which the temperature, pH and oxidation-reduction potential values are controlled. In addition, a base is added to adjust the pH of this initial solution to a value comprised between 1 and 3, preferably between 1.5 and 2.5, and a carbon-based reducing agent is added to adjust the initial oxidation-reduction potential to a value comprised between 200 mV and 350 mV relative to the potential of a normal hydrogen electrode. The temperature of the solution is comprised between 1° and 90° C.

Control of the initial pH by means of the base prevents precipitation of undesirable crystalline phases, for example Fe₃(PO₄)₂ or Fe₂P₂O₇, which may form at pH values below 1.

By way of example, an aqueous solution of phosphoric acid is used as the phosphorus source, and an aqueous solution of ammonium hydroxide as the base. Aqueous solutions of phosphoric acid and ammonium hydroxide are prepared beforehand by dissolving their precursors in water. The concentration of the aqueous phosphoric acid solution is preferably comprised between 1 mol/L and 3 mol/L. The concentration of the aqueous ammonium hydroxide solution is comprised between 0.1 mol/L and 3 mol/L, preferably between 0.4 mol/L and 2 mol/L. Likewise, the reducing agent can be dissolved in water at a concentration comprised between 1 mol/L and 3 mol/L before the solution is introduced into the reactor.

As yet another example, a solution of carbon nanospheres is used whose mean diameter is comprised between 1 nm and 1 μm, preferably between 1 nm and 500 nm, as a source of carbon nano-objects.

The carbon nanospheres can be prepared beforehand by different synthesis methods. For example, they can be obtained via a hydrothermal reaction from a carbon source, for example sugar or its derivatives, in water, at a concentration comprised between 0.1 mol/L and 2 mol/L, the solution being brought to a temperature greater than 100° C., preferably to a temperature comprised between 150° C. and 200° C. for a period comprised between 2 h and 6 h. For example, the carbon nanospheres can be synthesized according to the protocol described in the document “RSC Adv., 2015, 5, 59491-59494”. The mean diameter of the carbon nanospheres can be adjusted by controlling synthesis parameters such as, for example, temperature, reaction time and precursor concentration.

Such a synthesis protocol makes it possible to obtain carbon nanospheres whose mean diameter is comprised between 1 nm and 500 nm. The diameter of carbon particles can be measured experimentally by transmission electron microscopy (TEM) or high resolution scanning electron microscopy (HRSEM). In addition, the carbon nanospheres obtained by such a synthesis protocol decompose advantageously at a temperature comprised between 400° C. and 700° C. Other synthesis methods based on a bottom-up approach can also be used to manufacture carbon nano-objects. Another example of a bottom-up method is microwave-assisted pyrolysis synthesis from a water-soluble carbon precursor such as sugar or its derivatives. The advantage of these methods resides in the fact that they are easy to implement and can be scaled up.

The double-walled precipitation reactor 10 used has, for example, a capacity of 4 L and it is also equipped with a mechanical stirrer 11, a collection valve 12 intended to collect the suspension at the end of synthesis in order to proceed to step E2, an oxidation-reduction potential measuring sensor 13, a pH measuring sensor 14, a temperature measuring sensor 15 and a thermostat 16 for regulating the temperature inside the reactor. The reactor can be heated, for example, by circulating hot water or steam in the double wall of the reactor or via a coil immersed in the initial solution contained in the reactor.

In step E1.2, the pH of the solution prepared in step E1.1 is adjusted to between 1 and 3, preferably between 1.5 and 2.5, using a base (LiOH, NH₄OH or other).

In step E1.3, the lithium source and the iron(II) source are gradually added to the solution resulting from step E1.2. The addition is preferably carried out so as to maintain the pH between 3.5 and 7.5, preferably between 5 and 7. Maintaining the pH at values below 7 avoids the formation of undesirable phases, such as for example Fe(OH)₃ or Li₃PO₄. Indeed, LiFePO₄ is not yet stable at this stage of the process; it could re-dissolve in the medium at acidic pH (below 3.5).

For example, a basic lithium source can be chosen so as to regulate the pH, for example an aqueous lithium hydroxide solution at a concentration comprised between 1 mol/L and 3 mol/L prepared beforehand by dissolving the lithium hydroxide salt and stored in a tank 17.

The iron(II) source is, for example, an aqueous solution of iron(II) sulfate whose concentration is comprised between 1 mol/L and 3 mol/L prepared beforehand in a tank 18 by dissolving solid iron(II) sulfate in water.

In order to automatically regulate the pH and maintain it within the targeted range, the lithium and iron sources can be introduced into reactor 10 using metering pumps 19 and 20 equipped with flow regulators 21 and 22 to control the flow rate of addition of these reagents 4 and 5 into the reactor 10. The reactor can also be equipped with a pH controller 23 connected to the regulator 21 of the metering pump 19 which supplies the reactor 10 with lithium hydroxide and which will regulate the injection flow rate of the lithium hydroxide as a function of the pH value measured by the pH sensor 14.

During step E1.2, the aqueous lithium hydroxide (LiOH) solution is added to the mixture containing the phosphorus source, the reducing agent and, as applicable, a growth controller, to adjust the pH to between 1 and 3, preferably between 1.5 and 2.5. Then the rest of the LiOH solution and iron sulfate are, for example, introduced into the reactor at a fixed flow rate comprised between 0.1 L/h and 2.5 L/h until the maximum tolerated pH value is reached. Then, during step E1.3, the lithium hydroxide solution or other base is introduced at a variable flow rate according to the pH setpoint set by the pH controller 23, so that the pH remains within the tolerated range until the LiOH solution is exhausted.

In step E1.4, the precipitation solution thus formed is kept under stirring until particles of the desired size and morphology are obtained. Step E1.4 is therefore a maturation step.

According to an alternative embodiment of step E1, the lithium, iron(II) and phosphorus sources, the carbon nano-objects and the reducing agent are introduced directly into the precipitation reactor. Then, the base, for example ammonium hydroxide solution, is introduced gradually, at a controlled flow rate, until the target pH value is reached.

Step E1 can be implemented with other orders of introduction of the reagents.

In the embodiments of step E1 described above, step E1 is carried out in a reactor 1 stirred, for example at a speed comprised between 800 revolutions per minute (rpm) and 1200 rpm. Alternatively, the precipitation reactor used in step E1 produces the LFP/C particles in continuous mode.

Preferably, the final oxidation-reduction potential (Ef) of the reaction mixture at the end of step E1 is comprised between 0 mV and 100 mV, even more preferably between 10 mV and 50 mV.

Finally, the method according to the invention advantageously comprises a single step E1 of synthesis in a liquid medium, preferably in an aqueous medium, of the LFP/C particles. As a result, the method does not require mechanical mixing, grinding and heat treatment steps to obtain said LFP/C particles. The cost-effectiveness of the method for preparing micro-nanostructured LFP/C particles by coprecipitation is improved. In addition, it is possible to control the morphology, the particle size and the porosity of the nanoporous LFP/C particles which will be obtained at the end of steps E2, E3 and E4 as described below simply by choosing the conditions for implementing this single synthesis step E1.

In a step E2, the LFP/C particles are separated from the precipitation solution. According to one embodiment, the solid-liquid separation is carried out by filtration, for example, using a filter press. Other mechanical separation methods, such as centrifugation, can be used. A wet LFP/C precipitate is thus obtained.

Step E2 may further comprise washing the wet LFP/C precipitate. According to one embodiment, washing is performed with water. Washing consists of removing impurities adsorbed on the surface of the LFP/C precipitate, for example, salts and metal ions that are soluble in water, as well as residual acid from step E1. The washing can be monitored by measuring the physicochemical properties of the washing liquid, for example, its pH or its ionic conductivity (in μS/cm). For example, washing should be continued until the pH of the wash solution is comprised between 6.5 and 7.5.

In a step E3, the wet LFP/C particles are dried. By way of example, drying can be performed under vacuum at a temperature comprised between 60° C. and 100° C. Alternatively, drying can be performed under an inert atmosphere, for example under a nitrogen atmosphere.

Alternatively, drying can be performed by the atomization method by spraying the suspension of LFP/C particles into a hot air flow reactor, for example using the B-290 mini-spray dryer from Buchi.

In one embodiment, especially when the reducing agent is non-carbon based or has a low carbon content, a carbon source is added to the LFP/C particle suspension before or after the drying step so that the particles are coated with a carbon film after the calcination step E4. Such a carbon source may optionally be added as early as step E1.

When the reducing agent is carbon-based, it can itself be the carbon source. To this end, the reducing agent is advantageously chosen to have good adsorption properties on the particles, in order to be present on the particles after step E2. If the residual carbon content at the end of step E2 is too low, the reducing agent can optionally be combined with an additional carbon source introduced in step E1 and/or E4.

In a step E4, the LFP/C particles dried in step E3 are calcined. As shown in step 4) of FIG. 4, calcination E4 leads to the thermal decomposition of the carbon nano-objects 7 previously incorporated within the secondary LFP/C particles 9 to form the pores 3 and to the thermal decomposition of the carbon source to form a carbon coating layer 24. At the end of calcination E4, the nanoporous LFP/C microparticles 1 containing the pores 3 and a carbon layer 24 are thus obtained.

The porosity of the LFP/C microparticles is generated by partial or total decomposition of the carbon nano-objects within the secondary LFP/C particles. The size and shape of the pores can thus be controlled by varying the shape and size of the carbon nano-objects.

The calcination can be carried out under an inert atmosphere, for example under a dinitrogen atmosphere, at a temperature comprised between 600° C. and 800° C. The calcination E4 is advantageously performed in a rotary furnace which allows better homogenization and homogeneous diffusion of heat within the material during the heat treatment. The residence time of the LFP/C particles in the furnace is comprised between 2 h and 15 h, preferably between 5 h and 10 h.

Alternatively, the calcination step E4 can be performed under an atmosphere comprising a mixture of an inert gas and a gaseous carbon source, for example a mixture of dinitrogen and propylene C₃H₆ or a mixture of dinitrogen and ethylene. The gas mixture may, for example, contain 1% to 5% of the gaseous carbon source. The gaseous carbon source present in the mixture makes it possible to deposit a layer of carbon in the vapor phase on the surface of the nanoporous LFP/C particles in order to improve the electrical conductivity of the final material.

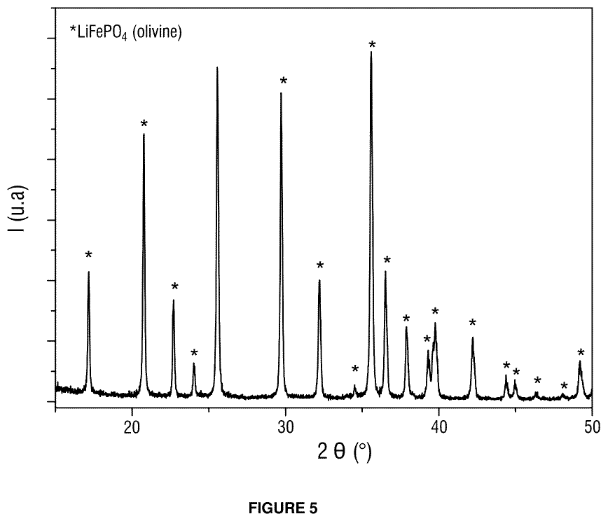

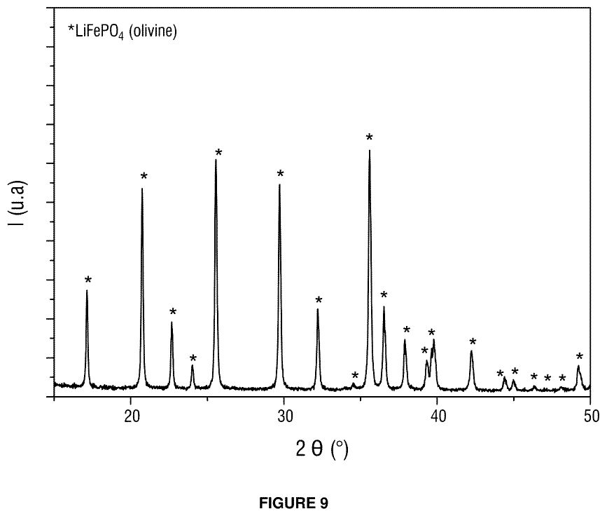

The crystal structure of the nanoporous LFP/C particles from calcination step E4 can then be identified by X-ray diffraction (XRD) using, for example, a PHILIPS X′Pert device with a copper anticathode of wavelength λ_{Cukα}=1.541 Å. Examples of X-ray diffractograms obtained on products from the embodiments covered by this invention are shown in FIGS. 5 and 9. The XRD results presented in FIGS. 5 and 9 show that the product obtained in step E4 is composed of LFP/C particles of olivine structure that is electrochemically active.

Finally, the mean diameter of the nanoporous LFP/C particles, the primary particles constituting them and the nanopores can be measured by high resolution scanning electron microscopy (HRSEM), for example, using a high resolution ZEISS scanning electron microscope.

Several examples of implementation of the method according to the invention by the inventors are described below (Examples 1 to 8). In these examples, embodiments of the method resulting in the manufacture of pure nanoporous lithium iron phosphate particles LFP/C are described. However, it is obvious to a person skilled in the art that other phosphate-based chemical compositions can be obtained within the scope of the present invention. For example, iron (Fe) can be replaced by other metals to obtain particles with the formula LiFe₍₁₋ₓ₎ MₓPO₄, where M is a metal that can be chosen, for example, from the following elements: Ni, Mn, Co, Ti, V, Nd, Mg, Zn, Y, Al, and W and 0<x<1. In addition, other core/shell type formulations having a transition metal concentration gradient comprised between the center and the periphery of the particles can also be obtained within the scope of this invention.

### Comparison Example 1

In this example, a coprecipitation step E1 was carried out. Firstly, 1 L of a solution of H₃PO₄ (1 M) is introduced into a 4 L reactor. Then 60 mL of a solution of NH₄OH (1 M) and 100 mL of a solution of glucose (1 M) are added to the solution of H₃PO₄ with mechanical stirring at 1000 rpm. The reactor is then closed and heated at 60° C. for 30 min. The initial pH of the mixture was adjusted to 2 using the prepared 2 M LiOH solution. The initial potential of the mixture was 350 mV. The remainder of the LiOH solution (2 M) and 1 L of a FeSO₄·7H₂O solution (1 M) were then added at a flow rate of 0.4 L/h and 0.3 L/h, respectively. The pHₘₐₓ setpoint was fixed at 7 while the pHₘᵢₙ value was fixed at 6.7. When the pHₘₐₓ setpoint value is reached, the automatic pH control is activated and the addition of LiOH·1H₂O solution stops automatically until the pHₘᵢₙ value is reached, in which case the LiOH solution addition pump starts again to reach the pHₘₐₓ value and so on until the LiOH solution is exhausted. The reaction mixture is then stirred at 60° C. for 10 h.

### Comparison Example 2

In this example, the intermediate LFP suspension obtained in Example 1 is used to carry out the solid-liquid separation and washing steps E2. In this test, approximately 3 L of the LFP suspension was filtered. The solid obtained is then washed several times with water. The effectiveness of the washing is monitored by measuring the conductivity of the filtrate (washing liquid) after each filtration with a conductivity meter. Table 1 shows the evolution of the ionic conductivity of the filtrate as a function of the number of washes.

TABLE 1

| Washing | 1 | 2 | 3 | 4 | 5 | 6 |
|---|---|---|---|---|---|---|
| Filtrate | 8000 | 4000 | 800 | 450 | 118 | 60 |
| conductivity | | | | | | |
| at 25° C. | | | | | | |
| (μS/cm) | | | | | | |

Table 1 shows that washing reduces the conductivity of the wash water to 60 μS/cm, a value close to that of the water used in this test. Next, a step E3 of drying the washed solid under vacuum is carried out in a vacuum oven at 90° C. for 12 h.

### Comparison Example 3

In this example, the washed and dried LFP precipitate of Example 2 is used to carry out a calcination step E4. In this test, approximately 25 g of the product of Example 2 were mixed with 2 g of anhydrous glucose (VWR Chemicals). The mixture is then dispersed in approximately 10 mL of ultrapure water and the mixture is placed in an ultrasonic bath for approximately 15 min. After evaporating the water and drying the mixture under vacuum, the product is transferred to an alumina crucible and then placed in a tubular furnace for 3 h at 150° C. and then 10 h at 700° C. under a stream of argon. Anhydrous glucose is a carbon source that forms a carbon film on the surface of particles during the calcination step.

FIG. 5 shows the result of X-ray diffraction analysis of the product obtained in Example 3. All the diffraction lines observed correspond to the positions of the reference LiFePO₄ (ASTM-JCPDS file number 40-1499) with an orthorhombic olivine structure. No other lines are observed indicating the absence of secondary phases in this product.

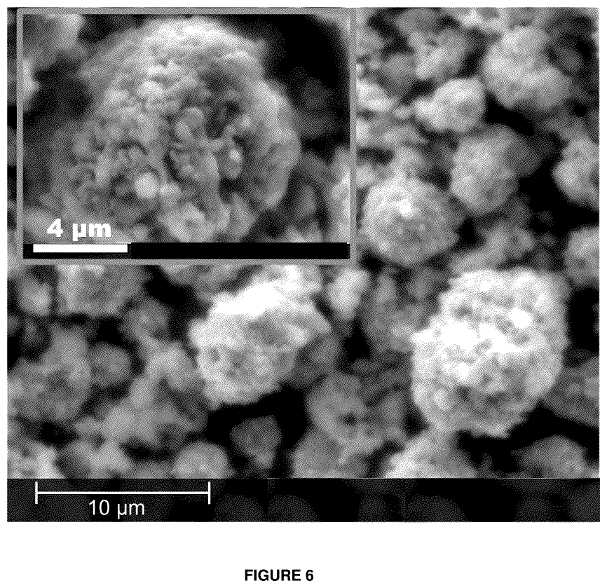

FIG. 6 shows an image taken by scanning electron microscopy (SEM) on the product obtained in Example 3. The image shows the formation of LFP/C particles of relatively homogeneous size and shape with a mean diameter of approximately 5 μm. A high magnification SEM image shows that the particles are formed by agglomeration of primary particles with a mean diameter of approximately 400 nm.

### Comparison Example 4

The LFP/C particles obtained in Example 3 were used to manufacture a positive electrode in order to evaluate their electrochemical properties in CR2025 button batteries. An LFP/C formulation was first prepared by mixing 8.5 g of the LFP/C powder of Example 3 with 1 g of a conductive material (acetylene black) and 0.5 g of binder (PVDF) in the N-methyl pyrrolidone (NMP) solvent. The electrode was prepared by depositing the LFP/C formulation on the surface of an aluminum foil using the doctor blade method. Metallic lithium was used as anode material. The cathodes were dried under vacuum at 85° C. for 24 h. The electrolyte used is a 1 M solution of lithium hexafluorophosphate (LiPF₆) in a mixture of ethylene carbonate (EC) and dimethyl carbonate (DMC) solvents prepared at a volume ratio of 1:1 (supplied by Merck). The batteries were then assembled in a glovebox protected from air and tested with the aid of a Biologic MPG-200 cycler under a C/10 charging and discharging regime.

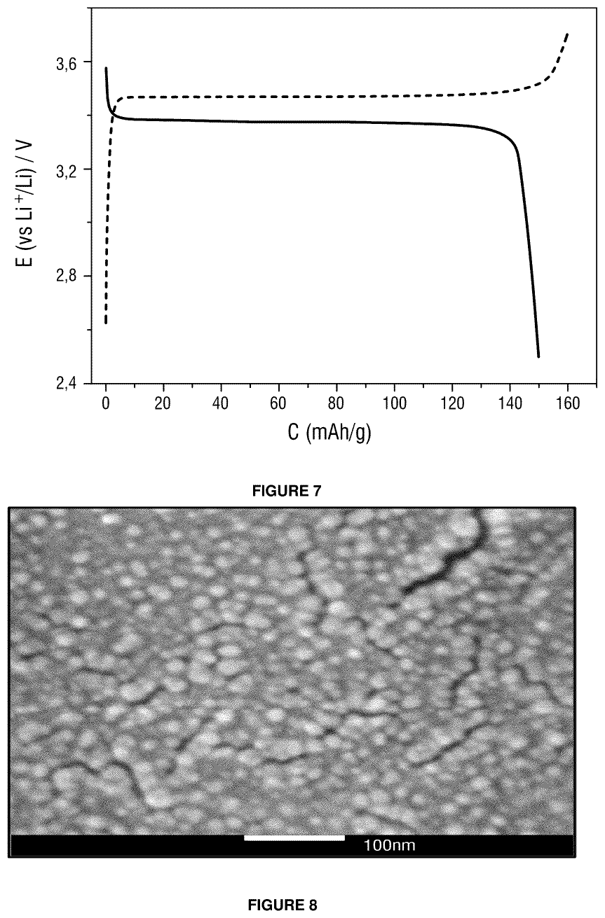

FIG. 7 shows the curve of the first charge and discharge cycle of a battery using the LFP/C particles of Example 3 as cathode material formulated as described in Example 4. This battery shows a low polarization (approximately 95 mV at 60 mA/g) and a relatively reversible charge/discharge process. The battery delivers a charge capacity of approximately 150 mAh/g.

### Example 5

In this example, carbon nanoparticles were synthesized. Firstly, a glucose solution was prepared by dissolving 15 g of glucose in 70 mL of distilled water. Then, 1 g citric acid was added to the glucose solution. Secondly, the solution was transferred to an autoclave and heated at 150° C. for 6 h.

FIG. 8 shows an image taken by scanning electron microscopy (SEM) in high resolution mode on a sample of the solution of carbon nanoparticles obtained in Example 5. The image shows the formation of carbon nanoparticles of homogeneous size and shape with a mean diameter of approximately 30 nm.

### Example 6

The carbon nanoparticles obtained in Example 5 were used to make nanoporous LFP/C particles. A precipitation step E1 was first performed under the following conditions. Firstly, 1 L of a solution of H₃PO₄ (1 M) is introduced into a 4 L reactor. Then 150 mL of a solution of NH₄OH (0.4 M) and 100 mL of a solution of glucose (1 M) are added to the solution of H₃PO₄ with mechanical stirring at 1000 rpm. The reactor is then closed and heated at 65° C. for 30 min. When the temperature has stabilized at 65° C., 40 mL of the suspension of carbon nanoparticles obtained in Example 5 were added. The pH of the solution was then adjusted to 2 using the LiOH solution prepared at 2 M. The remainder of the LiOH solution (2 M) and 1 L of a FeSO₄·7H₂O solution (1 M) were then added at a flow rate of 0.4 L/h and 0.3 L/h, respectively. The pHₘₐₓ setpoint was fixed at 7 while the pHₘᵢₙ value is fixed at 6.7. When the pHₘₐₓ setpoint value is reached, the automatic pH control is activated and the addition of LiOH·1H₂O solution stops automatically until the pHₘᵢₙ value is reached, in which case the LiOH solution addition pump starts again to reach the pHₘₐₓ value and so on until the LiOH solution is exhausted. The reaction mixture is then stirred at 65° C. for 12 h.

In this example, the solid-liquid separation and washing step E2 and the vacuum drying step E3 were also performed as in Example 2.

### Example 7

In this example, the LFP/carbon nanoparticle precipitate obtained in Example 6 is used to perform a calcination step E4. In this test, approximately 12.5 g of the product of Example 6 were mixed with 1 g of anhydrous glucose (VWR Chemicals). The mixture is then dispersed in approximately 5 mL of ultrapure water and placed in an ultrasonic bath for approximately 20 min. After evaporating the water and drying the mixture under vacuum, the product is transferred to an alumina crucible and then placed in a tubular furnace for 3 h at 150° C. and then 10 h at 700° C. under a stream of argon.

FIG. 9 shows the result of X-ray diffraction analysis of the product obtained in Example 7. All the diffraction lines observed correspond to the diffraction lines of LifePO₄ of olivine structure (ASTM-JCPDS file number 40-1499). No other crystalline phases are observed in this product.

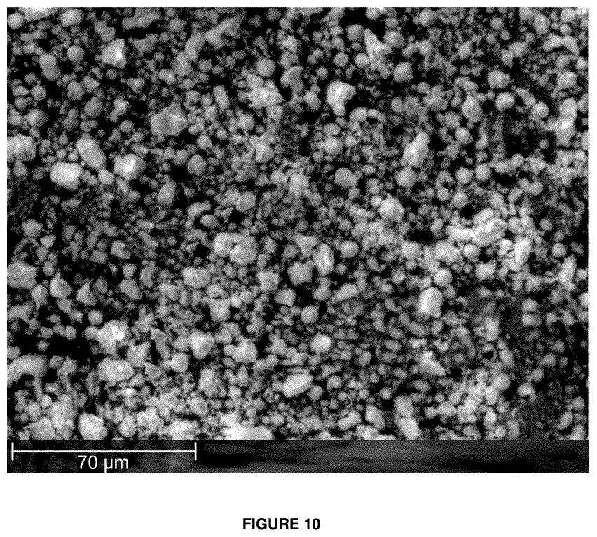

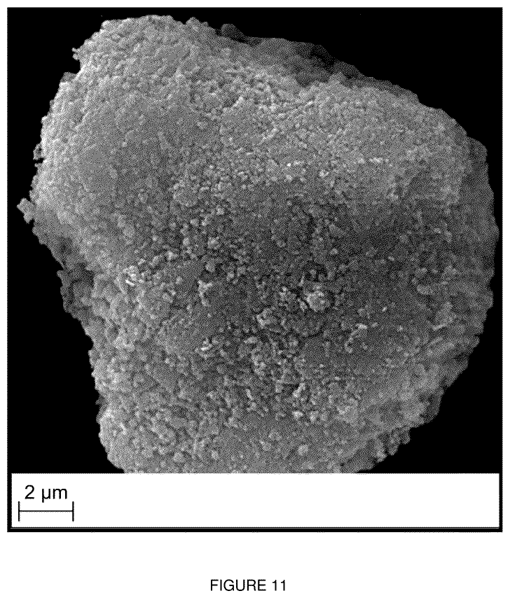

FIG. 10 shows an image taken by scanning electron microscopy (SEM) on the product obtained in Example 7. The image shows the formation of LFP/C particles of relatively homogeneous size and shape with a mean diameter of approximately 6 μm. A high magnification SEM image (FIG. 11) shows that secondary particles are formed by agglomeration of smaller particles (called primary particles) with a mean diameter of approximately 300 nm.

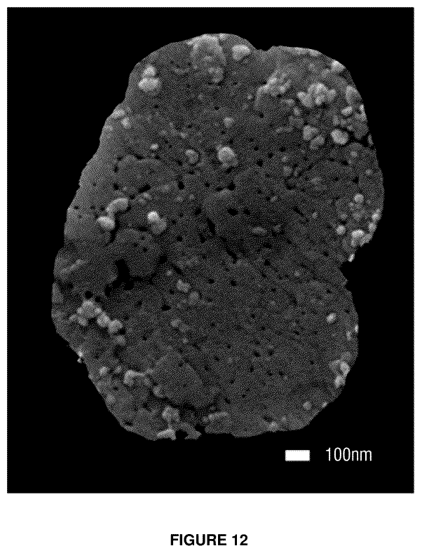

In addition, a polished section of the product obtained in Example 7 was produced by dispersing this product in a resin. FIG. 12 shows a SEM image taken on the section of a secondary particle taken from this product. The figure clearly shows that pores of relatively homogeneous sizes have formed within the particle. The mean diameter of these pores is approximately 30 nm, which corresponds to the mean diameter of the carbon nanoparticles used in this example. These pores are therefore the result of the thermal decomposition of carbon nanoparticles in the calcination step.

### Example 8

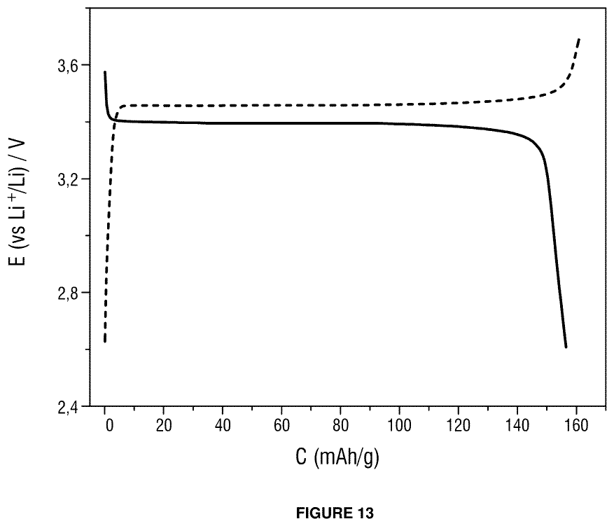

In this example, the nanoporous LFP/C powder obtained in Example 7 was used to manufacture a positive electrode in order to evaluate its electrochemical properties in CR2025 button batteries. The experimental conditions for the electrode preparation and the electrochemical test are similar to those described in Example 4. FIG. 13 shows the curve of the first charge-discharge cycle of a battery using the nanoporous LFP/C powder of Example 7 as the cathode material. The battery using nanoporous LFP/C powder clearly shows a lower polarization (only 63 mV at 60 mAh/g) compared to the battery of Example 4 (9 mV at 60 mAh/g) using non-porous LFP/C powder. In this example, the battery also has a reversible charge/discharge process and delivers a charge capacity of approximately 156 mAh/g. This example indicates that the porosity generated within the particles significantly improves the electrochemical performance of the battery.

1. A method for synthesizing a lithium-ion battery material consisting of nanoporous lithium iron phosphate particles (1), the method comprising the following steps:
(E1) forming a precipitation solution by mixing a lithium source (4), an iron(II) source (5), a phosphorus source (6), a reducing agent (8) and carbon nano-objects (7) in a solvent so as to coprecipitate lithium, iron and phosphorus around the carbon nano-objects in the form of particles, referred to as LFP/C (9), lithium iron phosphate particles incorporating the carbon nano-objects;
(E2) separating the LFP/C particles (9) from the precipitation solution;
(E3) drying the LFP/C particles (9);
(E4) calcining the LFP/C particles (9) so as to decompose the carbon nano-objects (7) incorporated in the particles, the decomposition of the nano-objects (7) generating nanopores (3) within the lithium iron phosphate particles.

2. The method according to claim 1, wherein the step (E4) comprises the formation of a coating layer (24) around the lithium iron phosphate particles by calcining a carbon source.

3. The method according to claim 2, wherein the reducing agent is carbon-based and the carbon source comprises said reducing agent.

4. The method according to claim 2, wherein the carbon source is added to the precipitation solution in step (E1).

5. The method according to claim 2, wherein the carbon source is added to the LFP/C particles in step (E4).

6. The method according to one of claims 1 to 5, wherein the carbon nano-objects are chosen so as to obtain, at the end of the calcination step (E4), nanopores of the same size as said carbon nano-objects.

7. The method according to one of claims 1 to 6, wherein the solvent is an aqueous solution and the carbon nano-objects are water soluble.

8. The method according to one of claims 1 to 7, wherein the carbon nano-objects comprise carbon quantum dots.

9. The method according to one of claims 1 to 8, wherein the carbon nano-objects are chosen to decompose at a temperature comprised between 40° and 700° C.

10. The method according to one of claims 1 to 9, wherein the carbon nano-objects are carbon nanoparticles obtained from sugars or sugar derivatives dissolved in water, at a concentration comprised between 0.1 M and 2 M, the solution being heated to a temperature greater than 100° C., preferably to a temperature comprised between 150° C. and 200° C. for a duration comprised between 2 h and 4 h.

11. The method according to one of claims 1 to 10, wherein step (E1) is carried out at atmospheric pressure in an open reactor at a temperature preferably comprised between 50° C. and 90° C.

12. The method according to one of claims 1 to 10, wherein the reducing agent used in step (E1) is carbon-based and is preferably chosen from sugars and sugar derivatives, organic acids and glycols.

13. The method according to one of claims 1 to 12, wherein the mean size of the nanopores within the lithium iron phosphate particles (1) is comprised between 1 nm and 500 nm.

14. The method according to one of claims 1 to 13, wherein each nanoporous lithium iron phosphate particle (1) is composed of primary particles (2), the mean diameter of the primary particles preferably being comprised between 50 nm and 500 nm and the mean diameter of the nanoporous lithium iron phosphate particles (1) preferably being comprised between 1 μm and 50 μm.

15. The method according to one of claims 1 to 14, wherein mixing step (E1) comprises the addition of a base so as to control the pH of the solution during coprecipitation, said base being chosen from the group comprising NH₄OH, NH₄HCO₃, NaOH, KOH, Na₂CO₃, Na₂C₂O₄ or a water soluble organic base.

16. The method according to one of claims 1 to 15, wherein the formation of the precipitation solution in step (E1) comprises mixing the phosphorus source, the carbon nano-objects, the base and the reducing agent prior to a gradual addition of the lithium source and the iron(II) source, the initial pH of the precipitation solution at the beginning of step (E1) before the introduction of the lithium source being comprised between 1 and 3, preferably between 1.5 and 2.5.

17. The method according to one of claims 1 to 16, wherein the final pH of the precipitation solution at the end of step (E1) is comprised between 3.5 and 7.5, preferably between 4.5 and 7.

18. An Li-ion rechargeable battery containing the nanoporous lithium iron phosphate particle material (1) obtained by the method according to one of claims 1 to 17.
